(19) United States
(12) Patent Application Publication
(10) Pub. No.: US 2026/0245907 A1
(43) Pub. Date: Aug. 20, 2026

(54) CONDUCTIVE COMPOSITE FOR LITHIUM-ION SECONDARY BATTERY, NEGATIVE ELECTRODE FOR LITHIUM-ION SECONDARY BATTERY, AND LITHIUM-ION SECONDARY BATTERY

(71) Applicant: TDK Corporation, Tokyo (JP)

(72) Inventors: Atsushi MONDEN, Tokyo (JP); Yuka MASUDA, Tokyo (JP); Ryosuke KIDO, Tokyo (JP); Hiroshi SASAGAWA, Tokyo (JP)

(73) Assignee: TDK Corporation, Tokyo (JP)

(21) Appl. No.: 19/164,371

(22) PCT Filed: Feb. 22, 2024
(86) PCT No.: PCT/JP2024/006455

§ 371 Date: Sep. 11, 2025

(30) Foreign Application Priority Data
Mar. 14, 2023 (JP) 2023-039922

(51) Int. Cl. H01M 4/62; H01M 4/02; H01M 4/38; H01M 10/0525

(52) U.S. Cl. CPC H01M 4/622; H01M 4/386; H01M 4/625; H01M 10/0525; H01M 2004/021; H01M 2004/027

(57) ABSTRACT

There is provided a conductive composite for a lithium-ion secondary battery, which is a composite of a polymer and a conductive material, where in a case where an aqueous dispersion of the composite is subjected to a particle diameter measurement by a dynamic light scattering method, a 50% cumulative diameter is 140 nm or more and 320 nm or less, and a 90% cumulative diameter is 700 nm or more and 3,400 nm or less.

### TECHNICAL FIELD

The present invention relates to a conductive composite for a lithium-ion secondary battery, a negative electrode for a lithium-ion secondary battery, and a lithium-ion secondary battery.

Priority is claimed on Japanese Patent Application No. 2023-039922, filed Mar. 14, 2023, the content of which is incorporated herein by reference.

### BACKGROUND ART

A lithium-ion secondary battery is widely used as a power source for a mobile device such as a mobile phone or a laptop computer, a hybrid car, or the like.

The capacity of the lithium-ion secondary battery mainly depends on the active material of the electrode. Graphite is generally used as the negative electrode active material. However, there is a demand for a negative electrode active material that provides a higher capacity. Therefore, silicon (Si), which has a much larger theoretical capacity as compared with the theoretical capacity of graphite (372 mAh/g), has attracted attention.

A negative electrode active material containing Si undergoes a large volume expansion during charging. The volume expansion of the negative electrode active material causes the deterioration of the cycle characteristics of the battery. In a case where the volume expansion of the negative electrode active material occurs, the decomposition or the like of the electrolyte solution occurs since, for example, the conductive path between the negative electrode active material layers is cut, peeling occurs at the interface between the negative electrode active material layer and the current collector, or cracking occurs in the solid electrolyte interphase (SEI) coating. These deteriorate the cycle characteristics of the battery.

For example, Patent Document 1 discloses an electrode for a lithium-ion secondary battery, which has a composite of carbon nanotubes and a binder. The composite of carbon nanotubes and a binder improves the binding properties between active material particles and the conductivity of electrodes.

### CITATION LIST

### Patent Document

Patent Document 1: Japanese Unexamined Patent Application, First Publication No. 2015-153714

### SUMMARY OF THE INVENTION

### Technical Problem

Cycle characteristics of a lithium-ion secondary battery are required to be improved by enhancing binding properties and conductivity between the negative electrode active materials and between the negative electrode active material layer and the current collector.

The present disclosure has been made in consideration of the above problems, and an object of the present disclosure is to provide a configuration that is capable of improving the cycle characteristics of a lithium-ion secondary battery.

### Solution to Problem

In order to solve the above problems, the following means are provided.
(1) A conductive composite for a lithium-ion secondary battery according to a first aspect is a composite of a polymer and a conductive material. In a case where an aqueous dispersion of the composite is subjected to a particle diameter measurement by a dynamic light scattering method, a 50% cumulative diameter is 140 nm or more and 320 nm or less, and a 90% cumulative diameter is 700 nm or more and 3,400 nm or less.
(2) In the conductive composite for a lithium-ion secondary battery according to the above-described aspect, the polymer may contain a carboxyl group or a carboxylate.
(3) In the conductive composite for a lithium-ion secondary battery according to the above-described aspect, the conductive material may include any one or more selected from the group consisting of activated carbon, graphite, carbon black, and carbon nanotubes.
(4) The negative electrode for a lithium-ion secondary battery according to a second aspect contains the conductive composite for a lithium-ion secondary battery according to the above-described aspect, and a negative electrode active material containing Si.
(5) A lithium-ion secondary battery according to a third aspect has a positive electrode, a negative electrode, a separator present between the positive electrode and the negative electrode, and an electrolyte solution, where the negative electrode is a negative electrode for a lithium-ion secondary battery according to the above-described aspect.

### Advantageous Effects of Invention

The lithium-ion secondary battery according to the above-described aspect has excellent cycle characteristics.

### BRIEF DESCRIPTION OF THE DRAWINGS

FIG. 1 A schematic view of a lithium-ion secondary battery according to a first embodiment.

FIG. 2 A scanning electron microscope image of a negative electrode active material according to the first embodiment.

FIG. 3 A schematic view of a particle size distribution of a conductive composite according to the first embodiment.

### DESCRIPTION OF EMBODIMENTS

Hereinafter, the embodiments will be described in detail with reference to the drawings as appropriate. The drawings that are used in the following description may show characteristic portions in an enlarged scale for the sake of convenience in order to facilitate the understanding of the characteristics, and thus the dimensional ratios or the like of the respective constitutional elements may differ from the actual ones. The materials, dimensions, and the like, which are exemplified in the following description, are merely examples, and the present invention is not limited thereto. Therefore, an appropriate modification can be made within the scope that does not deviate from the gist of the present invention.

### “Lithium-Ion Secondary Battery”

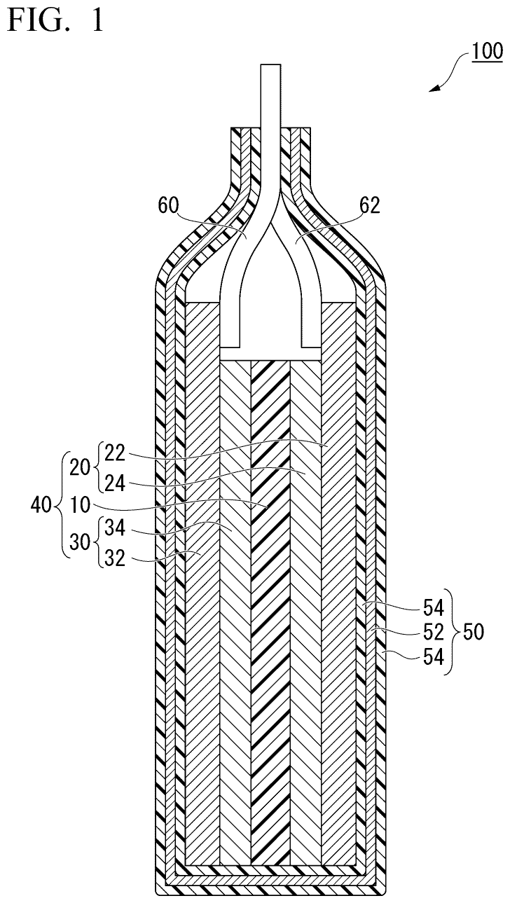

FIG. 1 is a schematic view of a lithium-ion secondary battery according to a first embodiment. A lithium-ion secondary battery 100 shown in FIG. 1 includes a power generation element 40, an exterior body 50, and a non-aqueous electrolyte solution (not shown in the drawing). The exterior body 50 covers the periphery of the power generation element 40. The power generation element 40 is connected to the outside through a pair of terminals 60 and 62 which are connected to the power generation element 40. The non-aqueous electrolyte solution is accommodated within the exterior body 50. Although FIG. 1 illustrates, as an example, a case in which one power generation element 40 is provided within the exterior body 50, a plurality of power generation elements 40 may be laminated.

### (Power Generation Element)

The power generation element 40 includes a separator 10, a positive electrode 20, and a negative electrode 30.

### <Positive Electrode>

The positive electrode 20 has, for example, a positive electrode current collector 22 and a positive electrode active material layer 24. The positive electrode active material layer 24 is in contact with at least one surface of the positive electrode current collector 22.

[Positive electrode current collector] The positive electrode current collector 22 is, for example, a conductive plate. The positive electrode current collector 22 is a thin plate of a metal, for example, aluminum, copper, nickel, titanium, or stainless steel. Aluminum, which is light weight, is suitably used for the positive electrode current collector 22. The average thickness of the positive electrode current collector 22 is, for example, 10 μm or more and 30 μm or less.

[Positive electrode active material layer] The positive electrode active material layer 24 contains, for example, a positive electrode active material. The positive electrode active material layer 24 may contain a conductive auxiliary agent and a binder as necessary.

The positive electrode active material layer contains an electrode active material that enables the reversible proceeding of absorbing and releasing of lithium ions, removing and inserting (intercalating) of lithium ions, or doping and dedoping of lithium ions and counter anions.

The positive electrode active material is, for example, a composite metal oxide. The composite metal oxide is, for example, lithium cobaltate (LiCoO₂), lithium nickelate (LiNiO₂), lithium manganate (LiMnO₂), and lithium manganese spinel (LiMn₂O₄), as well as a compound of a general formula: LiNiₓCo_{y}Mn_{z}MₐO₂ (in the general formula, x+y+z+a=1, 0≤x<1, 0≤y<1, 0≤z<1, and 0≤a<1 are satisfied, and M is one or more types of elements selected from Al, Mg, Nb, Ti, Cu, Zn, and Cr), a lithium Avanadium compound (LiV₂O₅), an olivine-type LiMPO₄ (here, M represents one or more types of elements selected from Co, Ni, Mn, Fe, Mg, Nb, Ti, Al, and Zr, or VO), lithium titanate (Li₄Ti₅O₁₂), and LiNiₓCo_{y}Al₂O₂ (0.9<x+y+z<1.1). The positive electrode active material may be an organic substance. For example, the positive electrode active material may be polyacetylene, polyaniline, polypyrrole, polythiophene, or polyacene.

The positive electrode active material may be a lithium-free material. Examples of the lithium-free material include FeF₃, a conjugated polymer containing an organic conductive substance, a Chevrel phase compound, a transition metal chalcogenide, a vanadium oxide, and a niobium oxide. As the lithium-free material, any one material described above may be used alone, or a plurality of the materials described above may be used in combination. In a case where the positive electrode active material is a lithium-free material, for example, an initial discharge is performed. Lithium is inserted into the positive electrode active material by discharging. In addition, the positive electrode active material as a lithium-free material may be pre-doped with lithium chemically or electrochemically.

The conductive auxiliary agent enhances electron conductivity between the positive electrode active materials. The conductive auxiliary agent is, for example, a carbon powder, a carbon nanotube, a carbon material, a fine metal powder, a mixture of a carbon material and a fine metal powder, or a conductive oxide. Examples of the carbon powder include carbon black, acetylene black, and Ketjen black. The fine metal powder is, for example, a powder of copper, nickel, stainless steel, or iron.

The content of the conductive auxiliary agent in the positive electrode active material layer 24 is not particularly limited. For example, with respect to the total mass of the positive electrode active material, the conductive auxiliary agent, and the binder, the content of the conductive auxiliary agent is 0.5 mass % or more and 20 mass % or less and is preferably 1 mass % or more and 5 mass % or less.

The binder in the positive electrode active material layer 24 binds the positive electrode active materials to each other. As the binder, a publicly known binder can be used. In addition, the binder may also be a conductive composite that is used for a negative electrode active material layer 34, which will be described later. The binder is preferably such as one that is insoluble in the electrolyte solution, has oxidation resistance, and has adhesiveness. The binder is, for example, a fluororesin. The binder is, for example, polyvinylidene fluoride (PVDF), polytetrafluoroethylene (PTFE), polyamide (PA), polyimide (PI), polyamideimide (PAI), polybenzimidazole (PBI), polyethersulfone (PES), a polyacrylic acid and a copolymer thereof, metal ion-crosslinked products of a polyacrylic acid and a copolymer thereof, polypropylene (PP) or polyethylene (PE) which is grafted with maleic anhydride, or a mixture thereof. The binder that is used in the positive electrode active material layer is particularly preferably PVDF.

The content of the binder in the positive electrode active material layer 24 is not particularly limited. For example, with respect to the total mass of the positive electrode active material, the conductive auxiliary agent, and the binder, the content of the binder is 1 mass % or more and 15 mass % or less and is preferably 1.5 mass % or more and 5 mass % or less. In a case where the binder content is low, the adhesion strength of the positive electrode 20 is weakened. In a case where the binder content is high, the energy density of the lithium-ion secondary battery 100 decreases since the binder is electrochemically inactive and thus does not contribute to the discharge capacity.

### <Negative Electrode>

The negative electrode 30 has, for example, a negative electrode current collector 32 and a negative electrode active material layer 34. The negative electrode active material layer 34 is formed on at least one surface of the negative electrode current collector 32.

[Negative electrode current collector] The negative electrode current collector 32 is, for example, a conductive plate. As the negative electrode current collector 32, the same one as in the positive electrode current collector 22 can be used.

[Negative electrode active material layer] The negative electrode active material layer 34 contains a negative electrode active material and a conductive composite.

The negative electrode active material includes, for example, silicon or a silicon compound. The silicon compound is, for example, a silicon alloy, a silicon oxide, or the like. For example, the silicon or silicon compound may be crystalline or amorphous. The amorphous silicon or silicon compound can be produced by a melt spinning method, a gas atomization method, or the like. The negative electrode active material may be an active material other than the silicon-based negative electrode active material.

Although not particularly limited, the content of silicon in the negative electrode active material may be 40 mass % to 100 mass %, may be 60 mass % to 100 mass %, may be 80 mass % to 100 mass %, may be 90 mass % to 100 mass %, or may be 95 mass % to 100 mass % with respect to the mass of the negative electrode active material.

The silicon alloy is represented by XₙSi. X is a cation. Examples of X include Ba, Mg, Al, Zn, Sn, Ca, V, Cr, Mn, Fe, Co, Ni, Cu, Zn, Ge, Y, Zr, Nb, Mo, W, Au, Ti, Na, and K. n satisfies 0≤n≤0.5. The silicon oxide is denoted as SiOₓ. x satisfies, for example, 0.8≤x≤2. The silicon oxide may consist of only SiO₂, may consist of only SiO, or may be a mixture of SiO and SiO₂. In addition, the silicon oxide may be such that some oxygen is deficient.

The negative electrode active material may be a composite of silicon or a composite of a silicon compound. The composite is such as one that is obtained by coating, with a conductive material, at least a part of the surface of the particle of the silicon or silicon compound. Examples of the conductive material include a carbon material, Al, Ti, Fe, Ni, Cu, Zn, Ag, and Sn. For example, a silicon carbon composite material (Si—C) is an example of the composite. The coating amount of the conductive material with respect to the particles of the silicon or silicon compound is, for example, 0.01 mass % to 30 mass % and preferably 0.1 mass % to 20 mass % with respect to the total mass of the composite. The composite can be produced by, for example, a mechanical alloying method, a chemical vapor deposition method, a wet method, a method of coating a polymer and then thermally decomposing and carbonizing the polymer, or the like.

A specific surface area of the negative electrode active material, which is determined by a BET method, is, for example, 0.5 m²/g or more and 100 m²/g or less, and preferably 1.0 m²/g or more and 20 m²/g or less. In a case where the specific surface area is small, Li ions are less likely to be inserted and eliminated between the negative electrode active materials. In a case where the specific surface area is large, a large quantity of binders is required for making an electrode, and thus the capacity per unit volume is reduced.

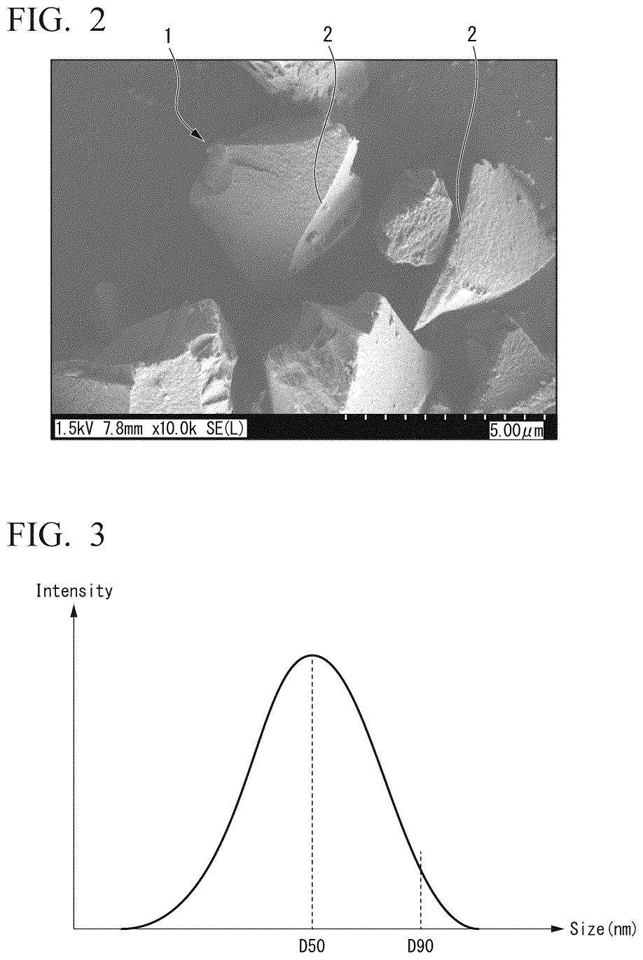

FIG. 2 is a scanning electron microscope (SEM) image of a negative electrode active material 1 according to the present embodiment. For example, the negative electrode active material 1 has an irregular shape and has a ridge line on the surface. The surface of the negative electrode active material 1 consists of a plurality of surfaces, and the boundary between these surfaces is a ridge line.

An average length of the ridge line 2 is, for example, 0.5 μm or more, and preferably 1.0 μm or more and 5.0 μm or less. The average length of the ridge line 2 is determined, for example, by dividing the sum of the lengths of the ridge lines 2 present in scanning electron microscope images captured at a magnification of 10,000 times, by the number of negative electrode active materials 1 containing the ridge line 2.

An angle formed by the two faces forming the ridge line 2 is, for example, 150° or less, and preferably 60° or more and 120° or less.

An average number of the ridge lines 2 included in one negative electrode active material 1 is, for example, 20 or less, and preferably 8 or more and 15 or less.

The particle diameter of the negative electrode active material is, for example, 0.5 μm or more, and preferably 1.0 μm or more and 5.0 μm or less. The particle diameter of the negative electrode active material can be determined as an average value from any 50 measured particles in terms of the major axis by subjecting a cross section of the negative electrode to measurement with a scanning electron microscope. It is noted that the particle diameter of the negative electrode active material cannot be measured by a dynamic light scattering method. This is because the negative electrode active material has a large bulk density and thus settles down in water. In a case of extracting the negative electrode active material and the conductive composite from the negative electrode, the particle diameter of the conductive composite can be evaluated by allowing the negative electrode active material to settle down and then evaluating the supernatant. The average length of the ridge line 2 is determined, for example, by dividing the sum of the lengths of the ridge lines 2 present in 10 scanning electron microscope images captured at a magnification of 10,000 times, by the number of negative electrode active materials 1 containing the ridge line 2.

The conductive composite is a composite of a polymer and a conductive material. The composite is a composite in which a polymer and a conductive material closely adhere to each other and are integrated. The type of polymer constituting the conductive composite is not limited to one type and may be two or more types. The type of conductive material constituting the conductive composite is not limited to one type and may be two or more types. The conductive composite is a plurality of particles having a predetermined particle size distribution, which will be described later.

The polymer constituting the conductive composite includes, for example, polytetrafluoroethylene (PTFE), polyvinylidene fluoride (PVDF), an ethylene-propylene-diene copolymer (EPDM), styrene butadiene rubber (SBR), carboxymethyl cellulose (CMC), polyacrylic acid, a copolymer of acrylic acid and vinyl alcohol, a copolymer of sodium acrylate and vinyl alcohol, sodium carboxymethyl cellulose, polynorbornene dicarboxylic acid, polymethacrylic acid, polyvinyl alcohol, polyimide, and polyamide.

The polymer constituting the conductive composite may contain, for example, a carboxyl group or a carboxylate. The carboxylate is a salt obtained by substituting a part of a carboxyl group with a metal ion such as Na. The polymer may contain both a carboxyl group and a carboxylate. A polymer containing both a carboxyl group and a carboxylate is obtained, for example, by ion exchange of a part of a carboxy group of a polymer having the carboxy group. A carboxy group takes on a role for binding between the negative electrode active material and the conductive composite, and the binding force between the negative electrode active material and the conductive composite is increased since the conductive composite has a carboxy group. In addition, in a case where a carboxylate is contained in the polymer, the polymer is prevented from undergoing intramolecular crosslinking, and the gelation of the conductive composite can be suppressed.

For example, polyacrylic acid, carboxymethyl cellulose (CMC), a copolymer of acrylic acid and vinyl alcohol, a copolymer of sodium acrylate and vinyl alcohol, sodium carboxymethyl cellulose, polynorbornene dicarboxylic acid, and polymethacrylic acid contain a carboxyl group or a carboxylate.

As the conductive material, for example, the same one as the conductive auxiliary agent contained in the positive electrode may be used. The conductive material may include, for example, any one or more selected from the group consisting of activated carbon, graphite, carbon black, and carbon nanotubes. These conductive materials become good conductors in a case of being formed into a composite with a polymer. Although not particularly limited, in a case where the conductive material contains any one or more selected from the group consisting of activated carbon, graphite, carbon black, and carbon nanotubes, the content of any one or more selected from the group consisting of activated carbon, graphite, carbon black, and carbon nanotubes with respect to the total mass of the conductive material may be 1 mass % or more and 100 mass % or less, may be 10 mass % or more and 100 mass % or less, or may be 50 mass % or more and 100 mass % or less.

In a case where an aqueous dispersion of the conductive composite is subjected to a particle diameter measurement by a dynamic light scattering method, a 50% cumulative diameter D50 is 140 nm or more and 320 nm or less, and a 90% cumulative diameter D90 is 700 nm or more and 3,400 nm or less. FIG. 3 is a schematic view of a particle size distribution of a conductive composite according to the first embodiment. FIG. 3 shows the particle size distribution as a frequency distribution. The particle size distribution is determined based on the scattering high intensity. The 50% cumulative diameter D50 is a particle diameter for which the value of the integrated distribution becomes 50% and the 90% cumulative diameter D90 is a particle diameter for which the value of the integrated distribution becomes 90%.

In a case where the conductive composite satisfies the relationship for the particle diameter described above, the particle size distribution of the conductive composite has a moderate variation. There are spaces of various sizes between the negative electrode active materials. This is because there are variations in the size of the negative electrode active material and the shape of the negative electrode active material is not constant. A conductive composite having a moderate variation in the particle size distribution can be present in spaces of various sizes between the negative electrode active materials, which makes it possible to enhance the binding properties between the negative electrode active materials.

The content of the conductive composite in the negative electrode active material layer 34 is not particularly limited. For example, the content of the conductive composite with respect to the total mass of the negative electrode active material and the conductive composite is 1 mass % or more and 20 mass % or less and is preferably 3 mass % or more and 15 mass % or less. In a case where the content of the conductive composite is small, the adhesion strength between the negative electrode active materials in the negative electrode 30 and the adhesion strength between the negative electrode active material layer 34 and the negative electrode current collector 32 are weakened. In a case where the content of the conductive composite is high, the energy density of the lithium-ion secondary battery 100 decreases since the conductive composite does not contribute to the discharge capacity.

The negative electrode active material layer 34 may contain a component other than the negative electrode active material and the conductive composite. For example, a crosslinking agent or the like may be contained. In a case where a crosslinking agent is added to the negative electrode active material layer 34, the conductive composites are likely to aggregate with each other, which makes it possible to control the variations in the distribution of the conductive composites. Examples of the crosslinking agent include an organic compound such as pyromellitic acid, 5,5-diethylbarbituric acid, 1,2,4-trihydroxybenzene, 1,3,5-trihydroxybenzene, 1,2,3-trihydroxybenzene, phthalic acid, isophthalic acid, terephthalic acid, or cyanuric acid; and a metal compound consisting of an organic ligand such as acetylacetone or bipyridine dicarboxylic acid, and a metal such as titanium, zirconia, nickel, cobalt, or manganese. Among them, a titanium compound is preferable, and examples thereof include titanium lactate, titanium triethanol aminate, a titanium lactate ammonium salt, titanium diethanol aminate, titanium aminoethyl aminate, or the like,

### <Separator>

The separator 10 is disposed between the positive electrode 20 and the negative electrode 30. The separator 10 separates the positive electrode 20 from the negative electrode 30 and prevents a short circuit between the positive electrode 20 and the negative electrode 30. The separator 10 extends in-plane along the positive electrode 20 and the negative electrode 30. Lithium ions can pass through the separator 10.

The separator 10 has, for example, a porous structure having electrical insulating properties. The separator 10 is, for example, a single layered body or laminate of a polyolefin film. The separator 10 may be a stretched film of a mixture of polyethylene, polypropylene, or the like. The separator 10 may be a fibrous nonwoven fabric consisting of at least one constitutional material selected from the group consisting of cellulose, polyester, polyacrylonitrile, polyamide, polyethylene, and polypropylene. The separator may be, for example, a solid electrolyte. The solid electrolyte is, for example, a polymeric solid electrolyte, an oxide-based solid electrolyte, or a sulfide-based solid electrolyte. The separator 10 may be an inorganic coated separator. The inorganic coated separator is such as one that is obtained by coating the surface of the above-described film with a mixture of a resin such as PVDF or CMC and an inorganic substance such as alumina or silica. The inorganic coated separator has an excellent heat resistance and suppresses the precipitation of transition metals eluted from the positive electrode, onto the surface of the negative electrode.

### <Electrolyte Solution>

The electrolyte solution is enclosed in the exterior body 50, and the power generation element 40 is impregnated with the electrolyte solution. The non-aqueous electrolyte solution contains, for example, a non-aqueous solvent and an electrolytic salt. The electrolytic salt is dissolved in a non-aqueous solvent.

As the electrolyte solution, a publicly known electrolyte solution may be used. The electrolyte solution includes, for example, a non-aqueous solvent and an electrolyte salt.

The electrolytic salt is, for example, a lithium salt. Examples of the electrolyte include LiPF₆, LiClO₄, LiBF₄, LiCF₃SO₃, LiCF₃CF₂SO₃, LiC(CF₃SO₂)₃, LiN(CF₃SO₂)₂, LiN(CF₃CF₂SO₂)₂, LiN(CF₃SO₂)(C₄F₉SO₂), LiN(CF₃CF₂CO)₂, LiBOB, and LiN(FSO₂)₂.

One type of lithium salt may be used alone, or two or more thereof may be used in combination. From the viewpoint of the degree of ionization, the electrolyte preferably contains LiPF₆.

The non-aqueous solvent may be, for example, an aprotic organic solvent. The organic solvent includes, for example, a cyclic carbonate, a linear carbonate, an ether, a mixture thereof, and the like.

The cyclic carbonate solvates the electrolyte. The cyclic carbonate includes, for example, ethylene carbonate, propylene carbonate, butylene carbonate, and fluoroethylene carbonate. It is preferable that the cyclic carbonate includes at least fluoroethylene carbonate. Fluoroethylene carbonate (FEC) has a high redox potential and is easily reduced and decomposed. In a case where a part of fluoroethylene carbonate (FEC) is reduced and decomposed, the electrolyte and the remaining solvent in the electrolyte solution are less likely to be decomposed. In addition, the fluoroethylene carbonate (FEC) forms a thin and stable coating film (SEI coating film) on the entire surface of the negative electrode active material at the initial stage of use of the lithium-ion secondary battery. The SEI film prevents direct contact between the negative electrode active material and the electrolyte and prevents the decomposition of the electrolyte solution.

A linear carbonate reduces the viscosity of the cyclic carbonate. Examples of the linear carbonate include diethyl carbonate, dimethyl carbonate, and ethyl methyl carbonate. As the non-aqueous solvent, others such as methyl acetate, ethyl acetate, methyl propionate, ethyl propionate, propyl propionate, γ-butyrolactone, 1,2-dimethoxyethane, and 1,2-diethoxyethane may be contained.

### <Exterior Body>

The exterior body 50 seals, in the inside thereof, the power generation element and the non-aqueous electrolyte solution. The exterior body 50 suppresses the leakage of the non-aqueous electrolyte solution to the outside, the infiltration of moisture or the like into the inside of the lithium-ion secondary battery 100 from the outside.

As shown in FIG. 1, the exterior body 50 has, for example, a metal foil 52 and a resin layer 54 laminated on each side of the metal foil 52. The exterior body 50 is a metal laminate film that is obtained by coating the metal foil 52 on both sides with a polymer film (resin layer 54).

As the metal foil 52, for example, an aluminum foil can be used. For the resin layer 54, a polymer film such as polypropylene can be used. The material that constitutes the resin layer 54 may be different between the inner side and the outer side. For example, as a material of the outer side, a polymer having a high melting point, for example, polyethylene terephthalate (PET) or polyamide (PA) can be used, and as a material of the polymer film for the inner side, polyethylene (PE), polypropylene (PP), or the like can be used.

### <Terminal>

Each of the terminals 60 and 62 is connected to each of the negative electrode 30 and the positive electrode 20. The terminal 60 connected to the negative electrode 30 is a negative electrode terminal, and the terminal 62 connected to the positive electrode 20 is a positive electrode terminal. The terminal 60 and the terminal 62 take on a role for electrical connection with the outside. The terminals 60 and the terminal 62 are formed from a conductive material such as aluminum, nickel, copper, or the like. The connection method may be welding or screwing. The terminals 60 and the terminal 62 are preferably protected with an insulating tape to prevent short circuits.

### “Manufacturing Method for Lithium-Ion Secondary Battery”

The lithium-ion secondary battery 100 is produced by producing the negative electrode 30, the positive electrode 20, the separator 10, the electrolyte solution, and the exterior body 50, and then assembling them. Hereinafter, one example of a manufacturing method for the lithium-ion secondary battery 100 will be described.

The negative electrode 30 is produced, for example, by sequentially carrying out a slurry production step, an electrode coating step, a drying step, and a rolling step.

The slurry production step is a step of producing a slurry by mixing a negative electrode active material (silicon or silicon compound), a conductive composite, and a solvent.

As the negative electrode active material, for example, an active material having an irregular shape is used. For example, one containing a predetermined ridge line may be selected from among those commercially available negative electrode active materials. In a case where the negative electrode active materials have an irregular shape, the negative electrode active materials are less likely to undergo closest packing with each other. In a case where a gap for volume expansion during charging and discharging is ensured in the negative electrode active material layer 34, electrode collapse is less likely to occur.

The negative electrode active material may be a negative electrode active material obtained by mixing active material particles and a conductive material while applying shear force and then allowing them to be formed into a composite. In a case where the active material particles are mixed by applying a shear force to the extent that the active material particles do not deteriorate, the surface of the active material particles is coated with the conductive material. In addition, the particle diameter of the negative electrode active material can also be adjusted according to the degree of this mixing. In addition, the negative electrode active material after production may also be sieved to have a uniform particle diameter.

A polymer and a conductive material are formed into a composite to obtain the conductive composite. For example, in a case where the polymer and the conductive material are added to a solvent such as water and stirred, the polymer and the conductive material are formed into a composite. In this case, the composite formation proceeds by enhancing the interaction between the polymer and the conductive material. For example, by adding a conductive material charged with a corona charging gun to a solvent or carrying out irradiation with ultraviolet rays during stirring, the interaction between the polymer and the conductive material is enhanced by activating the surface of the conductive material.

In addition, the particle size distribution of the conductive composite is changed by changing, for example, solvent type, stirring speed, temperature, stirring time, and the like, and can be adjusted by controlling them. The degree of aggregation of the polymer can be changed, for example, by selecting a good solvent for the polymer as the solvent and appropriately adding a poor solvent to the good solvent. In a case where the degree of aggregation of the polymer changes, the particle size distribution of the conductive composite changes. In addition, by adjusting the stirring rate, the solvent temperature, and the stirring time, the particle size distribution of the conductive composite can also be controlled by changing the probability of collision between the conductive composites.

In addition, a crosslinking agent may be added to the polymer and the conductive material during the production of the conductive composite. In a case where a crosslinking agent is added, the conductive composites are easily aggregated with each other, and the particle size distribution of the conductive composites is easily controlled in a predetermined range.

The solvent is, for example, water. The composition ratio of the negative electrode active material to the conductive composite is preferably 70 wt % to 99 wt %: 1 wt % to 30 wt % in terms of mass ratio. The mass ratio thereof is adjusted so that the total is 100 wt %.

The electrode coating step is a step of coating the surface of the negative electrode current collector 32 with a slurry. The coating method for the slurry is not particularly limited. For example, a slit die coating method or a doctor blade method can be used as the coating method for the slurry.

The drying step is a step of removing a solvent from the slurry. For example, the negative electrode current collector 32 coated with slurry is dried in an atmosphere of 60° C. to 200° C. According to such a procedure, the negative electrode active material layer 34 is formed on the negative electrode current collector 32.

The rolling step is carried out as necessary. The rolling step is a step of applying pressure to the negative electrode active material layer 34 to adjust the density of the negative electrode active material layer 34. The rolling step is carried out, for example, using a roll press device.

The positive electrode 20 can be produced according to the same procedure as the procedure for the negative electrode 30. As the separator 10 and the exterior body 50, commercially available ones can be used.

Next, the produced positive electrode 20 and negative electrode 30 are laminated so that the separator 10 is located between them, whereby the power generation element is produced. In a case where the power generation element 40 is a wound body, the positive electrode 20, the negative electrode 30, and the separator 10 are wound around with one end side thereof as an axis.

Finally, the power generation element 40 is enclosed in the exterior body 50. The non-aqueous electrolyte solution is injected into the exterior body 50. After the non-aqueous electrolyte solution is injected, decompression, heating, or the like is carried out to impregnate the power generation element 40 with the non-aqueous electrolyte solution. Heat or the like is applied to seal the exterior body 50, whereby the lithium-ion secondary battery 100 is obtained. It is noted that instead of injecting the electrolyte solution into the exterior body 50, the power generation element 40 may be impregnated with the electrolyte solution.

The lithium-ion secondary battery 100 according to the first embodiment has excellent cycle characteristics due to containing a conductive composite of which the particle size distribution satisfies a predetermined condition. This is considered to be because a conductive composite having a moderate variation in the particle size distribution is present in spaces of various sizes between the negative electrode active materials, and thus the binding properties between the negative electrode active materials and the binding properties between the negative electrode active material layer 34 and the negative electrode current collector 32 are improved. In addition, it is considered to be because a composite having conductivity is present between the negative electrode active materials and between the negative electrode active material layer 34 and the negative electrode current collector 32, and thus the conductive path between them can be ensured.

As described above, the embodiments according to the present invention have been described in detail with reference to the drawings. However, each of the configurations and the combination thereof in each embodiment are examples, and additions, omissions, substitutions, and other modifications of the configuration can be made without departing from the spirit of the present invention.

### EXAMPLES

### Example 1

A positive electrode slurry was applied onto one surface of an aluminum foil having a thickness of 15 μm. The positive electrode slurry was produced by mixing a positive electrode active material, a conductive auxiliary agent, a binder, and a solvent.

LiₓCoO₂ was used as the positive electrode active material. Acetylene black was used as the conductive auxiliary agent. Polyvinylidene fluoride (PVDF) was used as the binder. N-methyl-2-pyrrolidone was used as the solvent. 97 parts by mass of the positive electrode active material, 1 part by mass of the conductive auxiliary agent, 2 parts by mass of the binder, and 70 parts by mass of the solvent were mixed to produce the positive electrode slurry. Loading the amount of the positive electrode active material in the positive electrode active material layer after drying was set to 25 mg/cm². The solvent was removed from the positive electrode slurry in the drying furnace to produce a positive electrode active material layer. The positive electrode active material layer was pressurized with a roll press to produce a positive electrode.

Next, the negative electrode slurry was applied onto one surface of a copper foil having a thickness of 10 μm. The negative electrode slurry was produced by mixing a negative electrode active material, a conductive composite, and a solvent.

As the negative electrode active material, silicon having a particle diameter (D50) of 3 μm was used. As the conductive composite, a conductive composite in which PVDF, carbon black, and carbon nanotubes were formed into a composite was used. The PVDF, the carbon black, and the carbon nanotubes were formed into a composite by irradiating them with ultraviolet light of 365 nm at 10 mW/cm² in dimethyl formamide while carrying out stirring at 60° C. and 1,000 rpm for 1 hour. After these were formed into a composite, dimethyl formamide was removed to obtain a conductive composite.

N-methylpyrrolidone was used as the solvent. 90 parts by mass of a negative electrode active material and 10 parts by mass of a conductive composite were mixed with water to produce a negative electrode slurry. The amount of the negative electrode active material carried in the negative electrode active material layer after drying was set to 2.5 mg/cm². The solvent was removed from the negative electrode slurry in the drying furnace to produce a negative electrode active material layer. The negative electrode active material layer was pressurized with a roll press and then treated and dried in a nitrogen atmosphere at 150° C. or higher for 5 hours.

Next, an electrolyte solution was produced. A solvent obtained by mixing at a mixing ratio of fluoroethylene carbonate (FEC):diethyl carbonate (DEC)=11:89 in terms of mass ratio was used as the solvent. LiPF₆ was used as the electrolytic salt. The concentration of LiPF₆ was set to 1 mol/L.

### (Production of Lithium-Ion Secondary Battery for Evaluation)

The produced negative electrode and positive electrode were laminated with a separator (porous polyethylene sheet) interposed between them so that the positive electrode active material layer and the negative electrode active material layer faced each other, whereby a laminate was obtained. A nickel negative electrode lead was attached to the negative electrode of the laminate. An aluminum positive electrode lead was attached to the positive electrode of the laminate. The positive electrode lead and the negative electrode lead were welded with an ultrasonic welding machine. This laminate was inserted into an exterior body made of an aluminum laminate film, and the exterior body was subjected to heat sealing except for one place on the periphery thereof, whereby a sealed portion was formed. Then, finally, the electrolyte solution was injected into the exterior body, and then the remaining one place was subjected to heat sealing while carrying out decompression with a vacuum sealer, whereby a lithium-ion secondary battery was produced.

(Measurement of Capacity Retention Rate after 500 Cycles)

The cycle characteristics of the lithium-ion secondary battery were measured. The cycle characteristics were measured using a secondary battery charging and discharging test device (manufactured by HOKUTO DENKO Corporation).

Charging at a constant current and a constant voltage (CC-CV charging) was carried out by a constant current charging at a charging rate of 0.5 C (a current value at which charging is completed in 1 hour in a case where constant current charging is carried out at 25° C.) until the battery voltage reached 4.2 V, and then discharging was carried out by a constant current discharging at a discharging rate of 1.0 C until the battery voltage reached 2.5 V (CC discharging). The discharge capacity after the completion of the charging and discharging was detected to determine a battery capacity Q₁ before the cycle test.

Regarding the battery of which the battery capacity Q₁ had been determined as above, using again the secondary battery charging and discharging test device, charging was carried out by charging at a constant current and a constant voltage at a charging rate of 0.5 C until the battery voltage reached 4.2 V, and then discharging was carried out by a constant current discharging at a discharging rate of 1.0 C until the battery voltage reached 2.5 V. The above-described charging and discharging were counted as one cycle, and 500 cycles of charging and discharging were carried out. Thereafter, the discharge capacity after the completion of the 500 cycles of charging and discharging was detected to determine a battery capacity Q₂ after 500 cycles.

From the capacities Q₁ and Q₂ obtained as above, a capacity retention rate E after 500 cycles was calculated. The capacity retention rate E is calculated according to E=Q₂/Q₁×100. The capacity retention rate of Example 1 was 69%.

### Example 2

Example 2 differs from Example 1 in terms of the fact that the particle size distribution of the conductive composite was changed and that a crosslinking agent was added in a case where the conductive composite is formed into a composite. The particle size distribution of the conductive composite was changed by adding a crosslinking agent. As the crosslinking agent in Example 2, pyromellitic acid was used. The other conditions were the same as in Example 1, and the capacity retention rate after 500 cycles was determined.

### Example 3

Example 3 differs from Example 1 in terms of the fact that the solvent in a case of adjusting the conductive composite was changed from dimethyl formamide to water, and the material of the polymer constituting the conductive composite and the particle size distribution of the conductive composite were changed. In Example 3, polyacrylic acid was used as the polymer constituting the conductive composite. The polyacrylic acid has a carboxy group. The carboxy group and carboxylate in the conductive composite can be obtained by extracting and analyzing the conductive composite from the produced electrode. In the conductive composite, —COOLi and —COOH have high water solubility and thus can be easily extracted from the electrode. The other conditions were the same as in Example 1, and the capacity retention rate after 500 cycles was determined.

### Example 4

Example 4 differs from Example 3 in terms of the fact that the particle size distribution of the conductive composite was changed and that a crosslinking agent was added in a case where the conductive composite is formed into a composite. The particle size distribution of the conductive composite was changed by adding a crosslinking agent. As the crosslinking agent in Example 4, pyromellitic acid was used. The other points were set to be the same as in Example 3, and the capacity retention rate after 500 cycles was determined.

### Examples 5 and 6

Examples 5 and 6 differ from Example 4 in terms of the fact that the type of crosslinking agent to be added in a case where the conductive composite was formed into a composite was changed. By changing the type of crosslinking agent, the particle size distribution of the conductive composite changed. Terephthalic acid was used as a crosslinking agent in Example 5. Cyanuric acid was used as a crosslinking agent in Example 6. The other points were set to be the same as in Example 4, and the capacity retention rate after 500 cycles was determined.

### Example 7

Example 7 differs from Example 3 in terms of the fact that the material of the polymer constituting the conductive composite and the particle size distribution of the conductive composite were changed and that a crosslinking agent was added in a case where the polymer material constituting the conductive composite. In Example 7, as the polymer constituting the conductive composite, a polymer obtained by mixing polyvinyl alcohol and polyacrylic acid was used. In Example 7, 1,2,4-trihydroxybenzene was used as the crosslinking agent. The other points were set to be the same as in Example 3, and the capacity retention rate after 500 cycles was determined.

### Examples 8 and 9

Examples 8 and 9 differ from Example 3 in terms of the fact that the material of the polymer constituting the conductive composite, the material of the conductive material, and the particle size distribution of the conductive composite were changed and that a crosslinking agent was added in a case where the polymer material constituting the conductive composite. In Examples 8 and 9, a polymer obtained by mixing carboxymethyl cellulose and polyacrylic acid was used as the polymer constituting the conductive composite. In addition, in Example 8, graphite and carbon nanotubes were used as the conductive material constituting the conductive composite. In Example 9, carbon black and activated carbon were used as the conductive material constituting the conductive composite. In Examples 8 and 9, a titanium complex was used as the crosslinking agent. The other points were set to be the same as in Example 3, and the capacity retention rate after 500 cycles was determined.

### Comparative Example 1

Comparative Example 1 differs from Example 1 in terms of the fact that the particle size distribution of the conductive composite was changed. The particle size distribution of the conductive composite was changed by carrying out irradiation with ultraviolet light of 365 nm at 10 mW/cm² in dimethylformamide while carrying out stirring at 25° C. and 500 rpm for 0.5 hours. The other conditions were the same as in Example 1, and the capacity retention rate after 500 cycles was determined.

### Comparative Example 2

Comparative Example 2 differs from Example 4 in terms of the fact that the particle size distribution of the conductive composite was changed. The particle size distribution of the conductive composite was changed by carrying out irradiation with ultraviolet light of 365 nm at 10 mW/cm² in water while carrying out stirring at 80° C. and 1,500 rpm for 10 hours. The other points were set to be the same as in Example 4, and the capacity retention rate after 500 cycles was determined.

### Comparative Example 3

Comparative Example 3 differs from Example 4 in terms of the fact that the particle size distribution of the conductive composite was changed. The particle size distribution of the conductive composite was changed by carrying out irradiation with ultraviolet light of 365 nm at 10 mW/cm² in water while carrying out stirring at 80° C. and 1,500 rpm for 15 hours. The other points were set to be the same as in Example 4, and the capacity retention rate after 500 cycles was determined.

The conditions and measurement results of the conductive composites in Examples 1 to 9 and Comparative Examples 1 to 3 are shown in Table 1 below.

TABLE 1

| | | | | Presence or | | | | |
|---|---|---|---|---|---|---|---|---|
| | | | | absence of | | Presence or | | |
| | | | | carboxy | | absence of | | |
| | D50 | D90 | | group or | Type of conductive | crosslinking | Type of crosslinking | Capacity |
| | (nm) | (nm) | Type of polymer | carboxylate | material | agent | agent | retention rate (%) |
| Example 1 | 145 | 708 | PVDF | Absent | Carbon black | Absent | — | 69 |
| | | | | | Carbon nanotube | | | |
| Example 2 | 221 | 1819 | PVDF | Absent | Carbon black | Present | Pyromellitic Acid | 71 |
| | | | | | Carbon nanotube | | | |
| Example 3 | 185 | 1510 | Polyacrylic Acid | Present | Carbon black | Absent | — | 74 |
| | | | | | Carbon nanotube | | | |
| Example 4 | 316 | 3385 | Polyacrylic Acid | Present | Carbon black | Present | Pyromellitic Acid | 80 |
| | | | | | Carbon nanotube | | | |
| Example 5 | 285 | 1845 | Polyacrylic Acid | Present | Carbon black | Present | Terephthalic Acid | 77 |
| | | | | | Carbon nanotube | | | |
| Example 6 | 305 | 2896 | Polyacrylic Acid | Present | Carbon black | Present | Cyanuric Acid | 79 |
| | | | | | Carbon nanotube | | | |
| Example 7 | 277 | 2560 | Polyvinyl alcohol + | Present | Carbon black | Present | 1,2,4-tricarboxylic | 76 |
| | | | polyacrylic Acid | | Carbon nanotube | | benzene | |
| Example 8 | 155 | 1989 | Carboxymethyl cellulose + | Present | Graphite | Present | Titanium complex | 76 |
| | | | polyacrylic acid | | Carbon nanotube | | | |
| Example 9 | 243 | 2221 | Carboxymethyl cellulose + | Present | Carbon black | Present | Titanium complex | 77 |
| | | | polyacrylic Acid | | Activated carbon | | | |
| Comparative | 105 | 324 | PVDF | Absent | Carbon black | Absent | — | 35 |
| Example 1 | | | | | Carbon nanotube | | | |
| Comparative | 356 | 4803 | Polyacrylic Acid | Present | Carbon black | Present | Pyromellitic Acid | 54 |
| Example 2 | | | | | Carbon nanotube | | | |
| Comparative | 985 | 4989 | Polyacrylic Acid | Present | Carbon black | Present | Pyromellitic Acid | 37 |
| Example 3 | | | | | Carbon nanotube | | | |

In any of Examples 1 to 9, the capacity retention rate was high as compared with Comparative Examples 1 to 3. This is considered to be because the conductive composite contained in the negative electrode active material layer 34 has entered the spaces of various sizes between the active materials and between the active material and the current collector foil. Since the conductive composite improved the conductivity and binding properties between the active materials and between the active material and the current collector foil, the lithium-ion secondary battery according to each of Examples 1 to 9 had excellent cycle characteristics.

### INDUSTRIAL APPLICABILITY

According to the present invention, it is possible to provide a lithium-ion secondary battery having excellent cycle characteristics.

### REFERENCE SIGNS LIST

10 Separator
20 Positive electrode
22 Positive electrode current collector
24 Positive electrode active material layer
30 Negative electrode
32 Negative electrode current collector
34 Negative electrode active material layer
40 Power generation element
50 Exterior body
52 Metal foil
54 Resin layer
60, 62 Terminal
100 Lithium-ion secondary battery

1. A conductive composite for a lithium-ion secondary battery,
comprising a composite of a polymer and a conductive material,
wherein an aqueous dispersion of the composite is subjected to a particle diameter measurement by a dynamic light scattering method, a 50% cumulative diameter is 140 nm or more and 320 nm or less, and a 90% cumulative diameter is 700 nm or more and 3,400 nm or less.

2. The conductive composite for a lithium-ion secondary battery according to claim 1, wherein the polymer contains a carboxyl group or a carboxylate.

3. The conductive composite for a lithium-ion secondary battery according to claim 1, wherein the conductive material includes one or more selected from the group consisting of activated carbon, graphite, carbon black, and carbon nanotubes.

4. A negative electrode for a lithium-ion secondary battery, comprising:
the conductive composite for a lithium-ion secondary battery according to claim 1; and
a negative electrode active material containing Si.

5. A lithium-ion secondary battery comprising:
a positive electrode;
a negative electrode;
a separator present between the positive electrode and the negative electrode; and
an electrolyte solution,
wherein the negative electrode is the negative electrode for a lithium-ion secondary battery according to claim 4.

6. The conductive composite for a lithium-ion secondary battery according to claim 1, further comprising a cross-linking agent.

7. The conductive composite for a lithium-ion secondary battery according to claim 6, wherein the cross-linking agent containing a metal compound consisting of organic ligands and metals.

8. The conductive composite for a lithium-ion secondary battery according to claim 7, wherein the metal compound includes a titanium compound.

9. The negative electrode for a lithium-ion secondary battery according to claim 4, wherein the negative electrode active material has ridge lines on a surface.

10. The negative electrode for a lithium-ion secondary battery according to claim 9, wherein an average length of the ridge lines is 0.5 μm or more.

11. The negative electrode for a lithium-ion secondary battery according to claim 9, wherein an angle formed by the two faces forming the ridge line is 150° or less.

12. The negative electrode for a lithium-ion secondary battery according to claim 9, wherein an average number of the ridge lines in one negative electrode active material is 20 or less.
